(19) United States
(12) Patent Application Publication
(10) Pub. No.: US 2016/0148134 A1
(43) Pub. Date: May 26, 2016

(54) Method of Providing an Electronic Bail Posting Service

(71) Applicant: James Fields, Tinton Falls, NJ (US)

(72) Inventor: James Fields, Tinton Falls, NJ (US)

(21) Appl. No.: 14/948,832

(22) Filed: Nov. 23, 2015

Related U.S. Application Data
(60) Provisional application No. 62/047,654, filed on Nov. 24, 2014.

(51) Int. Cl. G06Q 10/06

(52) U.S. Cl. CPC G06Q 10/06311

(57) ABSTRACT

A method of providing an electronic bail posting service is used to create a network of bail-posting agents and companies. The method also allows companies to hire bounty hunters to retrieve clients. A server is used manage a plurality of company accounts, agent accounts, and bounty hunter accounts. Each of these accounts is used by companies, posting agents, and bounty hunters to network with each other. An employer computing device displays a plurality of feature options to be selected. The desired feature that is selected corresponds with a job request that is to be sent to a plurality of desired recipients which are designated by the server. A job request is sent to the desired recipients and a job acceptance confirmation is generated when a work-willing recipient accepts the job request. A job completion receipt is sent to the employer computing device once the job request has been fulfilled.

The current application claims a priority to the U.S. Provisional Patent application Ser. No. 62/047,654 filed on Nov. 24, 2014.

### FIELD OF THE INVENTION

The present invention relates generally to bail posting services and methods of networking between employers and employees. More specifically, the present invention is method of providing an electronic bail posting service which allows bail companies, posting agents, and bounty hunters to directly communicate and provide services to clients.

### BACKGROUND OF THE INVENTION

Bail posting services are most commonly provided by small businesses that employ posting agents to underwrite bail applications for clients. In this traditional system, bail companies may experience limitations on which jobs can be accepted based on a lack of manpower, funds, or various other conditions. While traditional bail posting services work well in many situations, many companies operate independently and have no network of assistance if a job cannot be completed by the company itself.

Accordingly, there is a present need for an electronic bail posting service which can be used to connect bail companies, posting agents, and bounty hunters. The present invention allows bail companies to manage posting agents in-house or can be used by companies to network with posting agents locally or nationwide. If a bail company is unable to post bail for a client due to a lack of manpower, the present invention may be used to find a posting agent that can underwrite a bail application for the bail company. Moreover, if a bail company cannot post bail for a client due to a lack of funds or insurance coverage, or if the client is from another state, the present invention may be used to locate another bail company that can provide the bail posting service instead. The present invention may also be used by bail companies to network with bounty hunters or bail enforcement agents to locate clients that fail to appear in court.

### BRIEF DESCRIPTION OF THE DRAWINGS

FIG. 1 is a flowchart describing the general process of the present invention.

FIG. 2 is a flow chart describing the steps of designating a plurality of desired recipients for a request agent feature.

FIG. 3 is a flow chart further describing the steps of designating a plurality of desired recipients for a request agent feature.

FIG. 4 is a flow chart describing the steps of sending a job request, generating a job acceptance confirmation, and sending a job completion receipt for a request agent feature.

FIG. 5 is a flow chart describing the steps of designating a plurality of desired recipients for a refer bail feature.

FIG. 6 is a flow chart describing the steps of sending a job request, generating a job acceptance confirmation, and sending a job completion receipt for a refer bail feature.

FIG. 7 is a flow chart describing the steps of designating a plurality of desired recipients for a fugitive recovery feature.

FIG. 8 is a flow chart further describing the steps of designating a plurality of desired recipients for a fugitive recovery feature.

FIG. 9 is a flow chart describing the steps of sending a job request, generating a job acceptance confirmation, and sending a job completion receipt for a request agent feature.

FIG. 10 is a flow chart describing the steps of entering a flagged client profile into the client blacklist

FIG. 11 is a flow chart describing the steps of searching for a flagged client profile within the client blacklist

FIG. 12 is a flow chart describing the steps of receiving a job review after a job request has been completed.

### DETAILED DESCRIPTION OF THE INVENTION

All illustrations of the drawings are for the purpose of describing selected versions of the present invention and are not intended to limit the scope of the present invention.

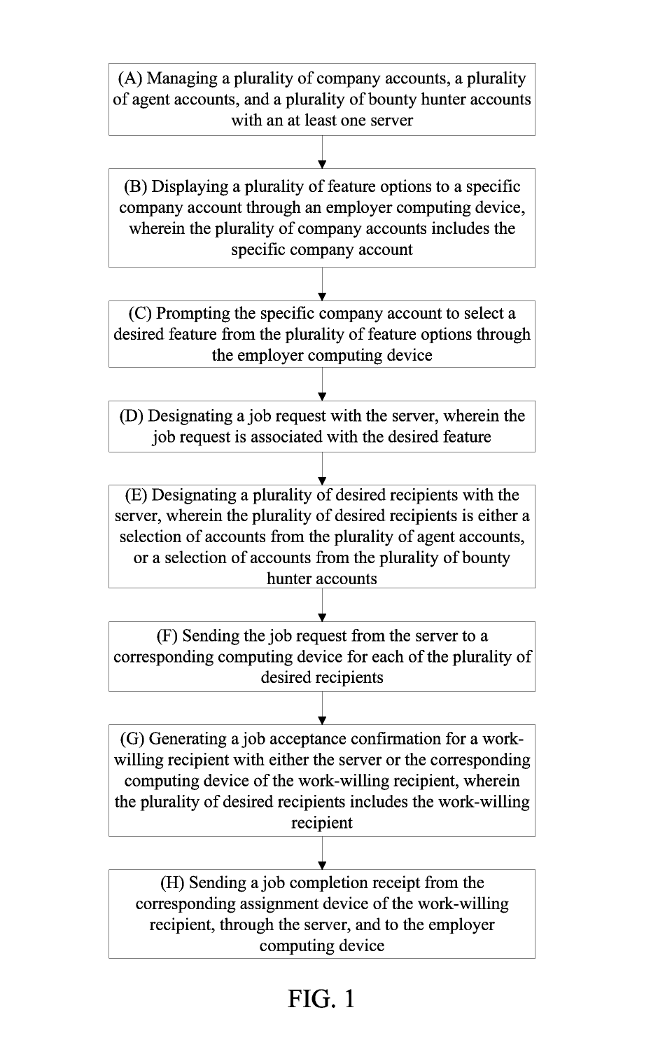

With reference to FIG. 1, the present invention is a method of providing an electronic bail posting service by executing computer-executable instructions stored on a non-transitory computer-readable medium. The present invention is used to easily manage the hiring of posting agents or bail companies to work for clients in need of bail. Moreover, the present invention can be used to hire a bounty hunter or bail enforcement agent to locate a client in the event that the client does not appear in court and the bail is forfeited. The present invention manages a plurality of company accounts, a plurality of agent accounts, and a plurality of bounty hunter accounts with an at least one server (Step A). The plurality of company accounts, is used by companies to access the present invention. Similarly, the plurality of agent accounts is used by posting agents and the plurality of bounty hunter accounts is used by bounty hunters to access the present invention. Together, the plurality of company accounts, the plurality of agent accounts and the plurality of bounty hunter accounts provide a means of networking between employers in need of completing jobs and job-seekers looking to complete said jobs. The server is accessible through the internet and allows information to be communicated between each of the plurality of company accounts, each of the plurality of agent accounts, and each of the plurality of bounty hunter accounts. A plurality of feature options is displayed to a specific company account through an employer computing device, wherein the plurality of company accounts includes the specific company account (Step B). The employer computing device is preferably a smartphone, but may alternatively be a computer, laptop, or any similar device capable of connecting to the server. The plurality of feature options allow the employer of the specific company to hire another company, a posting agent, or a bounty hunter to perform a job. To begin searching for a company, posting agent, or bounty hunter, the specific company account is first prompted to select a desired feature from the plurality of feature options through the employer computing device (Step C). The plurality of feature options includes, but is not limited to, a request agent feature, a refer bail feature, and a fugitive recovery feature. Additional features may also be included.

The request agent feature is used by the employer of a specific company account to hire or assign a posting agent to underwrite a bail application for a client. This feature may be used as a dispatching system for all of the posting agents in a single company, or may be used to create a network of posting agents which may be accessed by one or more companies. The refer bail feature is used by the employer of a specific company account to hire another company to provide posting services for a client. This is useful in situations where the employer of the specific company account is unable to provide posting services. This may occur due to a lack of employees, too high of a bail price, or if the client is requesting bail from a state other than the state in which the employer operates. With the refer bail feature, the employer of the specific company account is able to transfer the business transaction of providing positing services to a client while, in turn, charging a small fee. The fugitive recovery feature is used by the employer of the specific company account to locate and retrieve a client that has failed to appear in court. If the employer of the specific company account posted bail for a client that does not appear in court, the employer has the potential to lose all of the money used to bail the client out of jail. In this situation, the employer has an incentive to find and retrieve the client in order to have the bail money returned. To do this, the employer of the specific company account may hire a bounty hunter through the use of the fugitive recovery feature.

Once a desired feature is selected, a job request is designated with the server, wherein the job request is associated with the desired feature (Step D). The job request takes the form of a notification which details the requirements of a specific job and any relevant information that may be needed to complete the job. The nature of the job request determines which accounts receive a notification for the job request. A plurality of desired recipients is designated with the server, wherein the plurality of desired recipients is either a selection of accounts from the plurality of company accounts, a selection of accounts from the plurality of agent accounts, or a selection of accounts from the plurality of bounty hunter accounts (Step E). Specifically, the plurality of agent accounts is targeted for a job request that corresponds with the refer agent feature. Similarly, the plurality of company accounts is targeted for the refer bail feature, and the plurality of bounty hunter accounts is targeted for the fugitive recovery feature.

The job request is sent from the server to a corresponding computing device for each of the plurality of desired recipients (Step F). In the preferred embodiment of the present invention, each of the corresponding computing devices is a smartphone; however, computers, laptops, and other computing devices may alternatively be used. Depending on the type of job request, a job acceptance confirmation is generated for a work-willing recipient with either the server or the corresponding computing device of the work-willing recipient, wherein the plurality of desired recipients includes the work-willing recipient (Step G). The work-willing recipient is a posting agent, company, or bounty hunter that is looking to complete the job detailed in the job request. The job acceptance confirmation is a notification that alerts either the employer of the specific company account or the work-willing recipient that the job request has been accepted. For a request agent feature or a refer bail feature, the job acceptance confirmation is sent by the corresponding computing device to the server so that the employer of the specific company account can be notified that the job will be completed. Alternatively, for the fugitive recovery feature, the preferred embodiment of the present invention allows each of the plurality of desired recipients to bid on the ability to fulfill the job request. In this instance, the job acceptance confirmation is sent to the work-willing recipient so that the work-willing recipient knows that they have won the job. After the work-willing recipient successfully fulfills a job request, a job completion receipt is sent from the corresponding assignment device of the work-willing recipient, through the server, and to the employer computing device (Step H). The job completion receipt confirms that the work-willing recipient successfully fulfilled the job request, but may also be used to relay additional information to the specific company account, including, but not limited to, client information, co-signer information, and legal documents. In the preferred embodiment of the present invention, the job completion receipt is not only sent to the specific company account, but is also sent to the work-willing recipient, and the client. The job completion receipt may also be sent to an insurance company that works with the specific company account.

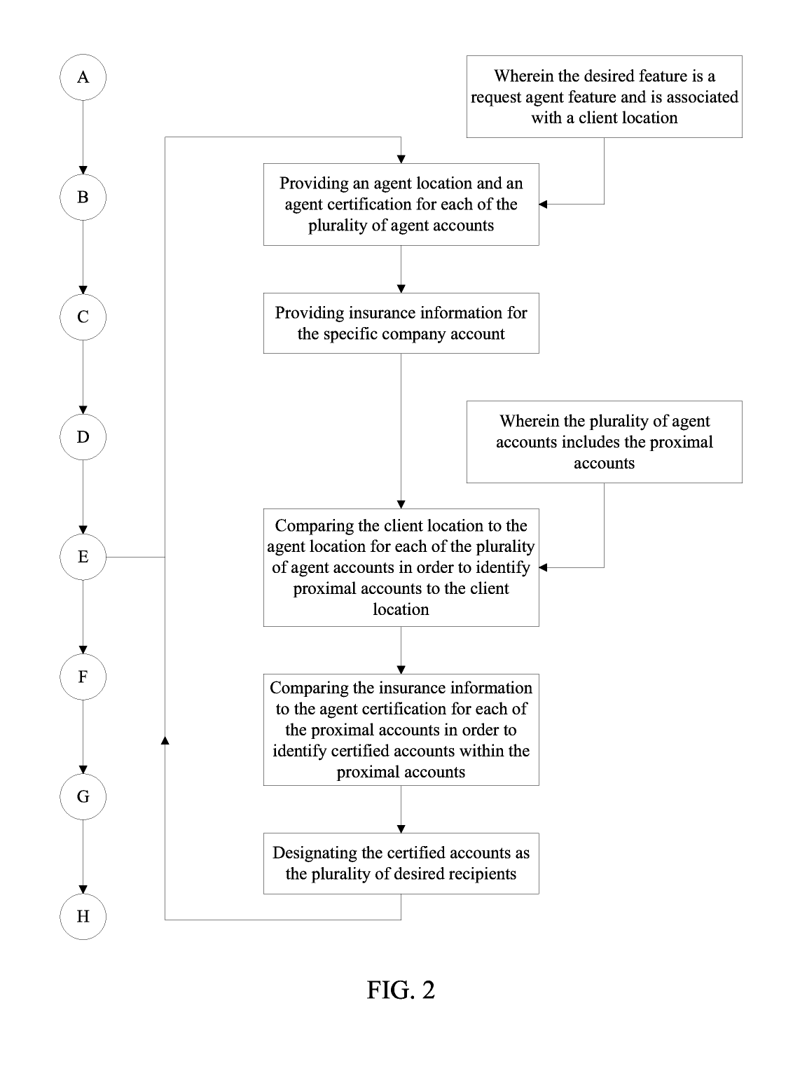

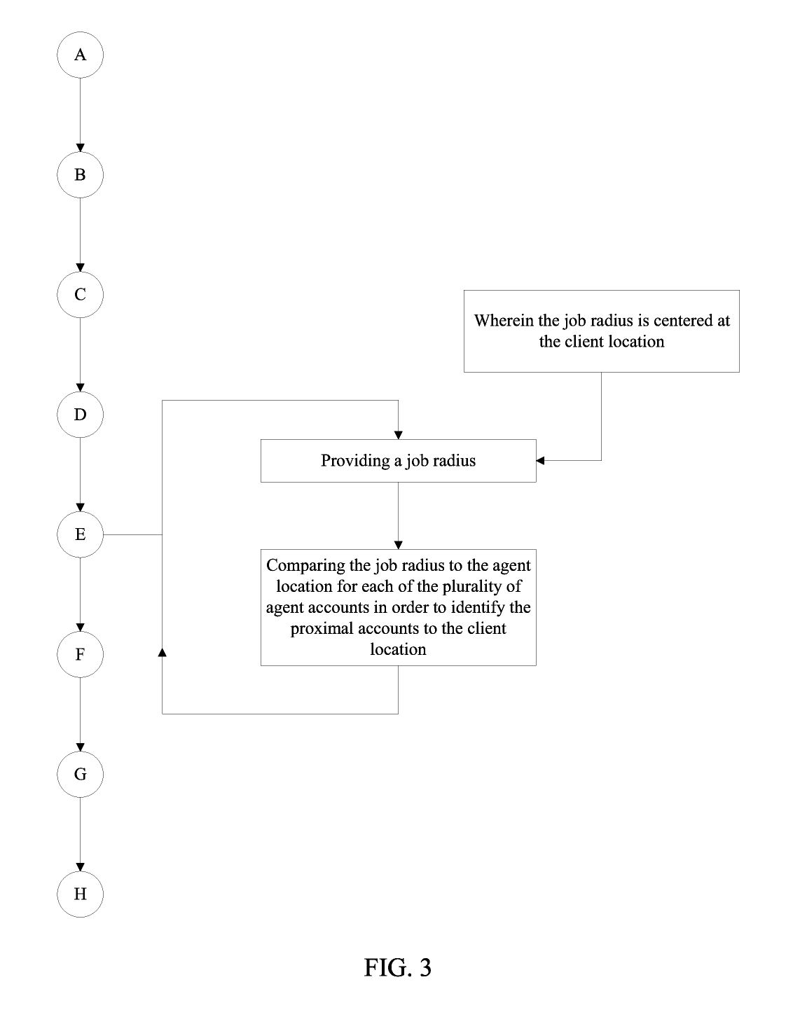

If the desired feature is a request agent feature, the work-willing recipient must be able to meet with the client in a reasonable amount of time. Accordingly, if the desired feature is a request agent feature, the desired feature is associated with a client location. The process used by the server to evaluate each of the plurality of agent accounts and identify desired recipients (Step E) uses the client location to filter out incompatible agent accounts. In reference to FIGS. 2-3, an agent location and an agent certification are provided for each of the plurality of agent accounts. In the preferred embodiment of the present invention, the agent location is a real-time geographical coordinate that is used to track the exact location of the agent on a map. The agent certification details which insurance companies the posting agent is certified to underwrite bail applications through. The agent location is directly compared with the client location. The agent certification is compared to the provided insurance information for the specific company account. The client location is compared to the agent location for each of the plurality of agent accounts in order to identify proximal accounts to the client location. The plurality of proximal accounts are agent accounts that are located closest to the client location. In the preferred embodiment of the present invention, a job radius is provided, wherein the job radius is centered at the client location. The job radius is compared to the agent location for each of the plurality of agent accounts in order to identify the proximal accounts to the client location. Alternatively, each of the agent accounts may be considered a proximal account simply by being located within the same state as the client. In addition, the insurance information is compared to the agent certification for each of the proximal accounts in order to identify certified accounts within the proximal accounts. This is done because in order for the employer of the specific company account to post bail for the client, the posting agent must have an insurance certification that matches the insurance company used by the employer. Having passed the screening process for location and insurance, the certified accounts are designated as the plurality of desired recipients.

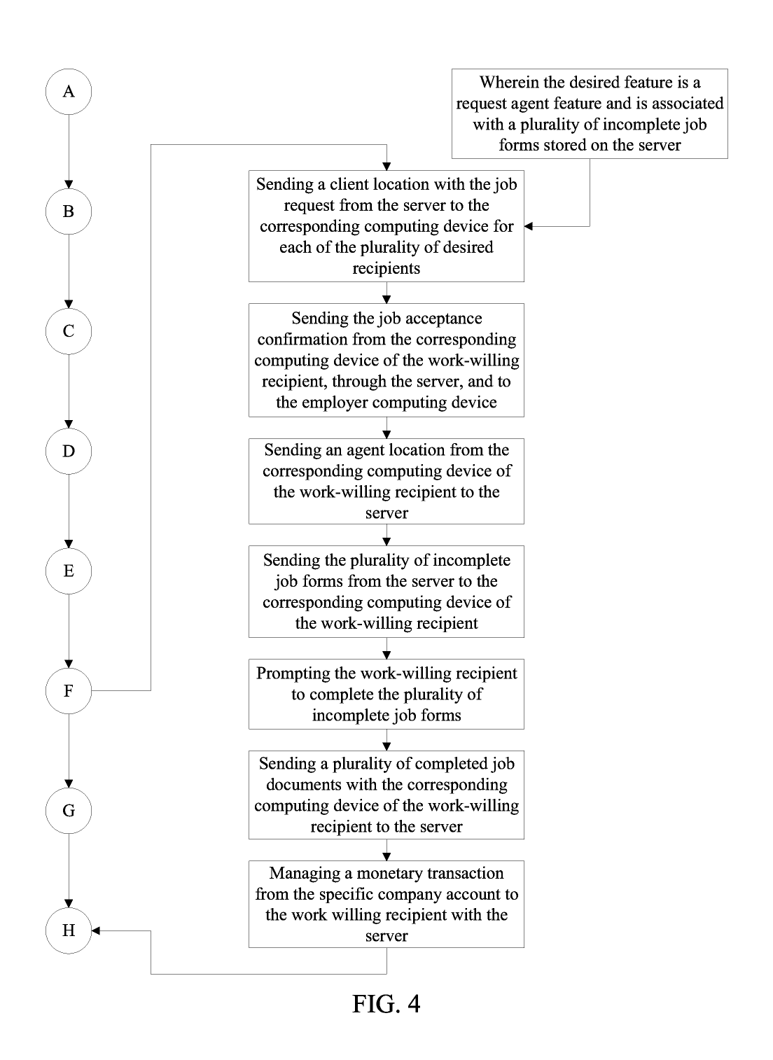

In reference to FIG. 4, the request agent feature is also associated with a plurality of incomplete job forms stored on the server. The plurality of incomplete job forms is filled out by the work-willing recipient so that bail may be posted for the client. The client location is sent with the job request (Step F) from the server to the corresponding computing device for each of the plurality of desired recipients so that the plurality of desired recipients may decide if the job request is worth accepting. After a work-willing recipient accepts the job request, the job acceptance confirmation is sent from the corresponding computing device of the work-willing recipient, through the server, and to the employer computing device (Step G). An agent location is sent from the corresponding computing device of the work-willing recipient to the server. This allows the employer computing device to monitor the location of the work-willing recipient. Additionally, the work-willing recipient is able to send a notification to the employer computing device once the work-willing recipient has arrived at the client location. Once at the client location, the work-willing recipient is prompted to complete the plurality of incomplete job forms through the corresponding computing device of the work-willing recipient. The plurality of job forms may be electronic documents or physical documents which are digitally scanned or photographed before being sent to the employer computing device. Moreover, the plurality of incomplete job forms may allow the work-willing recipient to attach photos of the client, the client's vehicle or driver's license, and also any co-signers present. Once the work-willing recipient has finished filling out the plurality of incomplete job forms, a plurality of completed job forms is sent with the corresponding computing device of the work-willing recipient to the server. This is included as part of the job completion receipt (Step H). Having received all information and documents necessary to post bail for the client, a monetary transaction is managed from the specific company account to the work-willing recipient with the server. The monetary transaction may be in the form of a direct electronic transfer of funds or may involve third party companies.

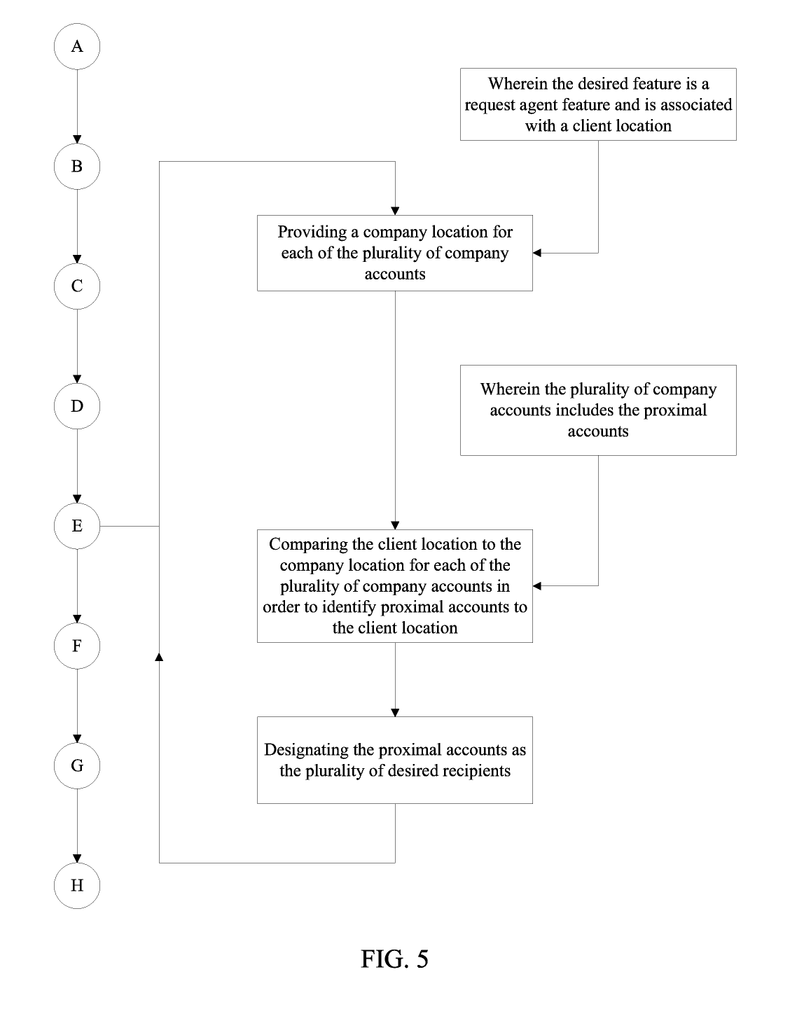

Similar to the request agent feature, if the desired feature is a refer bail feature, the work-willing recipient must be able to meet with the client. Accordingly, if the desired feature is a refer bail feature, the desired feature is associated with a client location. The process used by the server to evaluate each of the plurality of company accounts and identify desired recipients (Step E) uses the client location to filter out incompatible agent accounts. In reference to FIG. 5, a company location is provided for each of the plurality of company accounts. The client location is compared to the company location for each of the plurality of company accounts in order to identify proximal accounts to the client location. The plurality of proximal accounts are company accounts that are located closest to the client location. In the preferred embodiment of the present invention, the client location and the company location are compared based on state, without the use of a job radius. However, a job radius, or other comparison methods, may be used in alternative embodiments. Having passed the screening process for location, the proximal accounts are designated as the plurality of desired recipients.

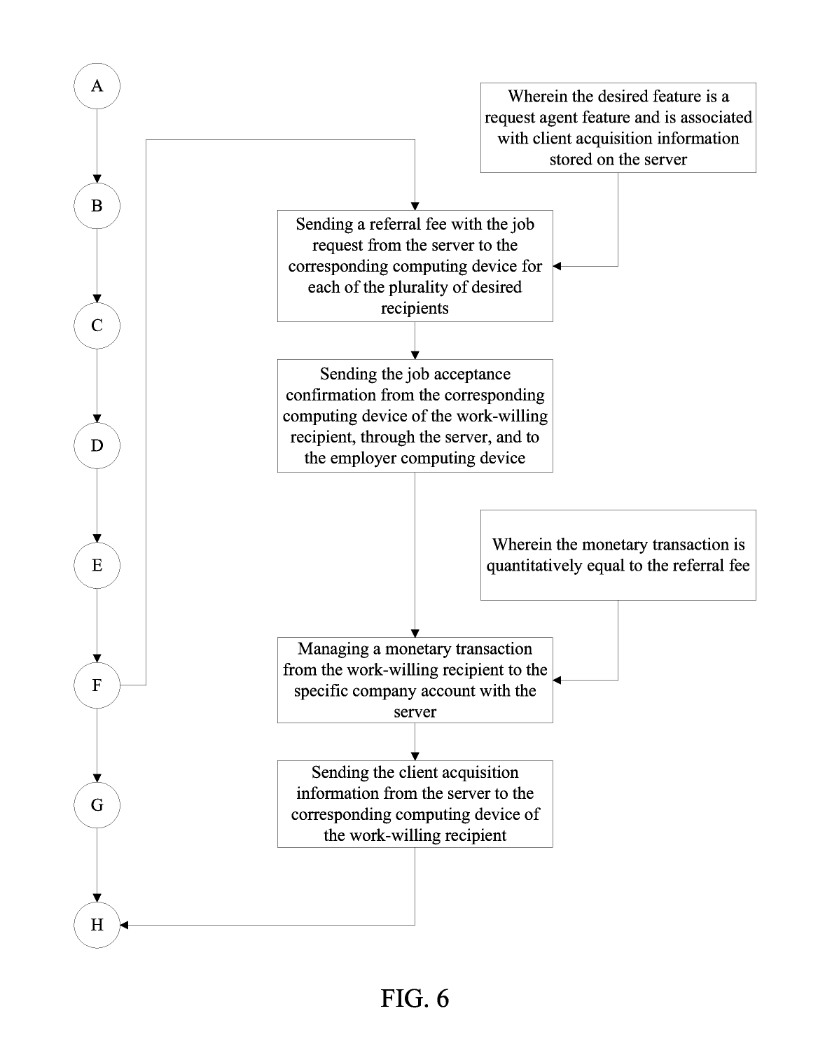

In reference to FIG. 6, the refer bail feature is also associated with client acquisition information stored on the server. The client acquisition information includes specific details about a client that allows a work-willing recipient to contact and work with the client. The client acquisition information is only sent to the work-willing recipient after the job request has been accepted. Initially, basic information may be sent to the plurality of desired recipients to help each of the desired recipients decide whether or not to accept a job request. Sending only basic information before a job request is accepted helps to prevent another company from undercutting the employer of the specific company account and stealing the client's business. A referral fee is sent with the job request from the server to the corresponding computing device for each of the plurality of desired recipients (Step F). The referral fee outlines the price in which the employer of the specific company account is willing to sell the job request for. After a work-willing recipient accepts the job request, the job acceptance confirmation is sent from the corresponding computing device of the work-willing recipient, through the server, and to the employer computing device (Step G). A monetary transaction is managed from the work-willing recipient to the specific company account with the server, wherein the monetary transaction is quantitatively equal to the referral fee. After the work-willing recipient has paid for and accepted the job request, the client acquisition information is sent from the server to the corresponding computing device of the work-willing recipient. The client acquisition information is sent as part of the job completion receipt (Step H).

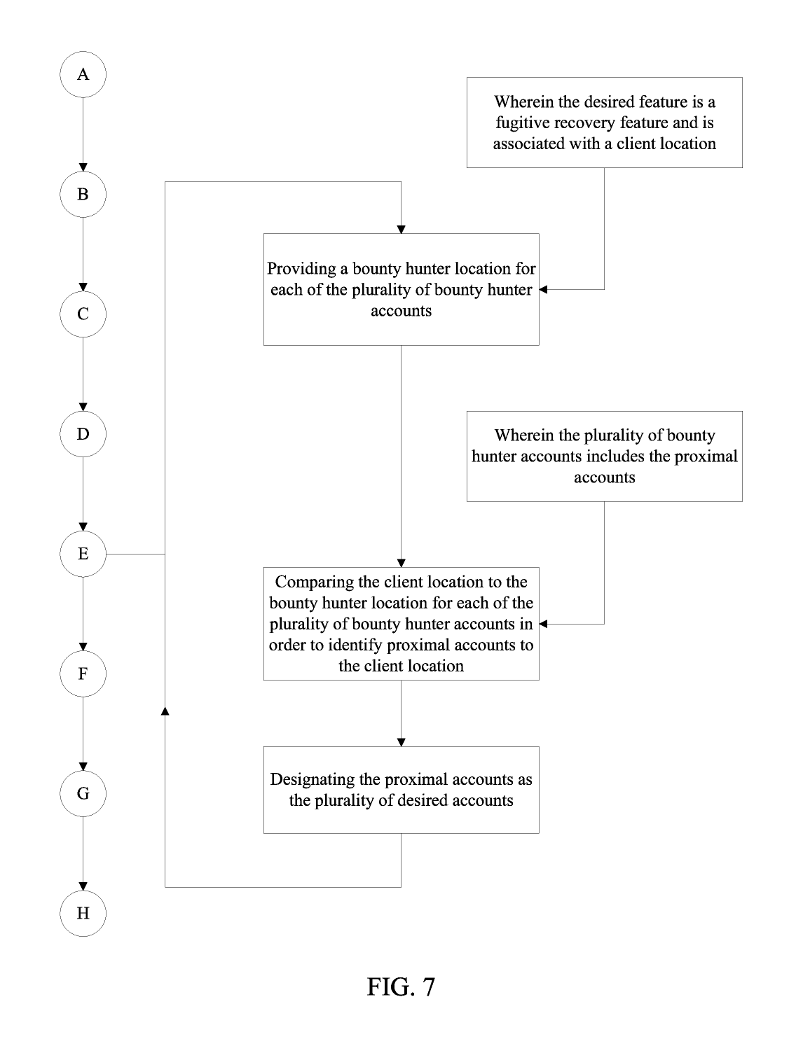

If the desired feature is a fugitive recovery feature, the work-willing recipient must geographically close to the client. Accordingly, if the desired feature is a fugitive recovery feature, the desired feature is associated with a client location. The process used by the server to evaluate each of the plurality of bounty hunter accounts and identify desired recipients (Step E) uses the client location to filter out incompatible bounty hunter accounts. In reference to FIG. 7, a bounty hunter location is provided for each of the plurality of bounty hunter accounts and is used for comparison with the client location. The client location is compared to the bounty hunter location for each of the plurality of bounty hunter accounts in order to identify proximal accounts to the client location. The proximal accounts are bounty hunter accounts which are located closest to the client location. In the preferred embodiment of the present invention, the client location and the bounty hunter are compared based on state, without the use of a job radius. However, a job radius, or other comparison methods, may be used in alternative embodiments. Having passed the screening process for location, the proximal accounts are designated as the plurality of desired recipients.

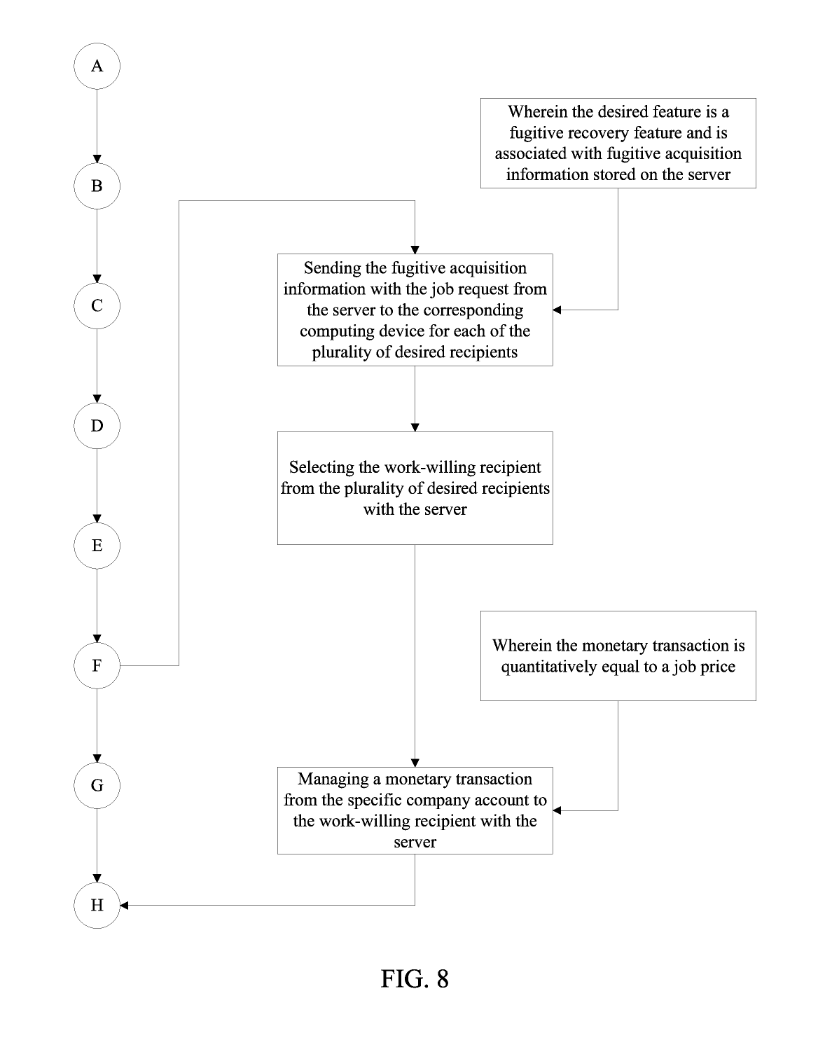

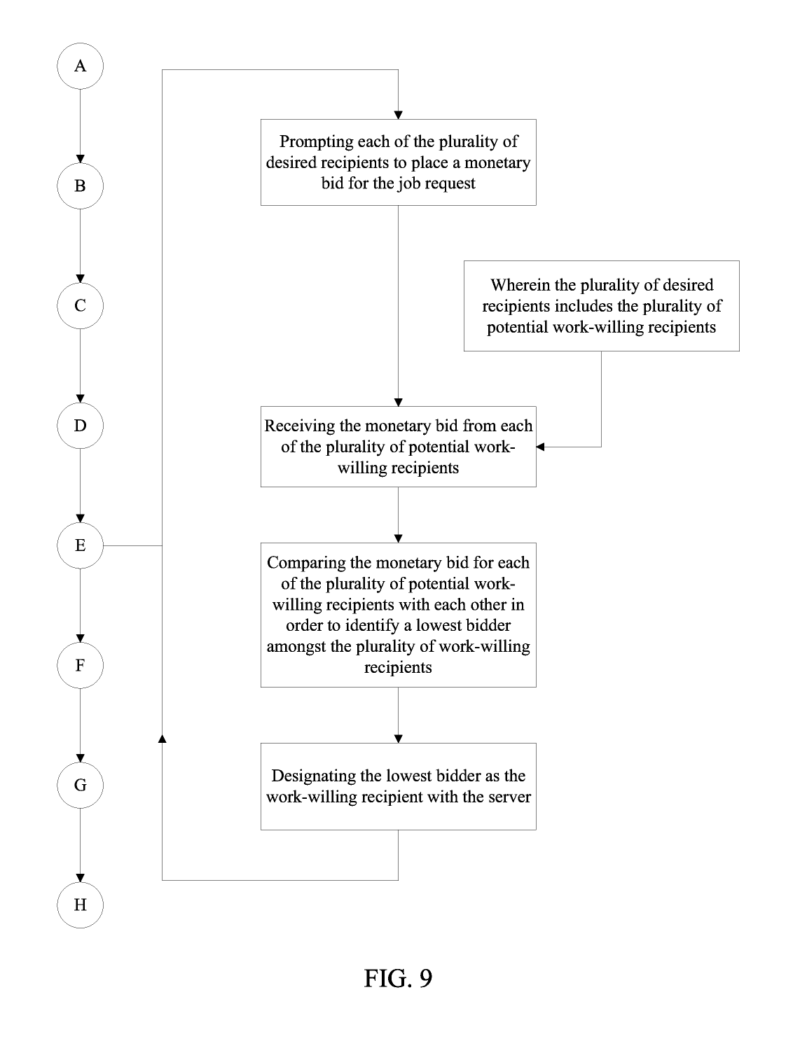

In reference to FIGS. 8-9, the fugitive recovery feature is also associated with fugitive acquisition information stored on the server. The fugitive acquisition information includes specific details about a client that allow a work-willing recipient to locate and retrieve the client. The fugitive acquisition information is sent with the job request from the server to the corresponding computing device for each of the plurality of desired recipients (Step F). This allows each of the plurality of desired recipients to determine if the job request is worth pursuing. The work-willing recipient is selected from the plurality of desired recipients with the server. In the preferred embodiment of the present invention, the selection of a work-willing recipient is determined by a bidding process. In the bidding process, each of the plurality of desired recipients is prompted to place a monetary bid for the job request. Monetary bids are received from each of a plurality of potential work-willing recipients, wherein the plurality of desired recipients includes the plurality of potential work-willing recipients. Any desired recipients that do not place a monetary bid are not considered for the job. The bidding process is used to find the work-willing recipient that is able to complete the job at the lowest cost. Monetary bids may be cut off by a time limit, a price threshold, or any other means. The monetary bids for each of the plurality of potential work-willing recipients are compared with each other in order to identify a lowest bidder amongst the plurality of potential work-willing recipients. The lowest bidder is designated as the work-willing recipient with the server and is ultimately granted the job. The monetary bid of the lowest bidder is designated as a job price with the server. The job price corresponds with how much money will be transferred from the specific company account to the work-willing recipient upon completion of the job request. In an alternative embodiment of the present invention, the work-willing recipient may be chosen based on a first come, first serve basis.

In the preferred embodiment of the present invention, wherein potential work-willing recipients must bid on the chance to fulfill a job request, a job acceptance confirmation is generated by the server and is sent to the corresponding computing device of the work-willing recipient (Step G). This notifies the work-willing recipient that they have successfully won the right to fulfill the job request. In the alternative embodiment, wherein the work-willing recipient is chosen on a first come, first serve basis, the job acceptance receipt is generated with the corresponding computing device of the work-willing recipient and sent through the server to the specific company account so that the employer of the specific company account is notified that the job request has been accepted. After the work-willing recipient has been selected, the server manages a monetary transaction from the specific company account to the work-willing recipient, wherein the monetary transaction is quantitatively equal to the job price. Similar to the request agent feature, the monetary transaction may be in the form of a direct electronic transfer of funds or may involve third party companies. In the preferred embodiment, the monetary transaction is associated with the monetary transaction between the work-willing recipient and the specific company account, indicating that the monetary transaction was successful and the job request has been completed (Step H).

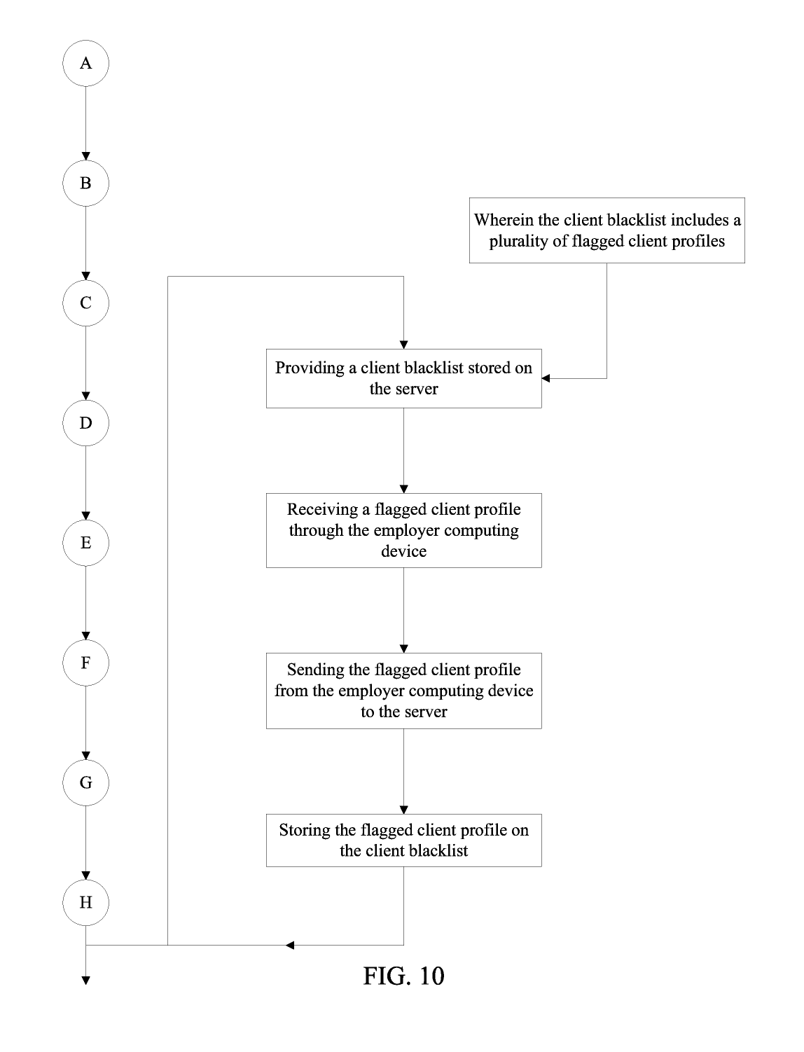

In reference to FIG. 10, a client blacklist is provided and stored on the server, wherein the client blacklist includes a plurality of flagged client profiles. The client blacklist is used to track clients who have previously failed to appear in court or have amassed debt with bail companies. In order to add a client to the client blacklist, a flagged client profile is received through the employer computing device. Generally, this is done by the employer of the specific company account after a client has not made a payment or appeared in court. The flagged client profile is then sent from the employer computing device to the server and is stored on the client blacklist.

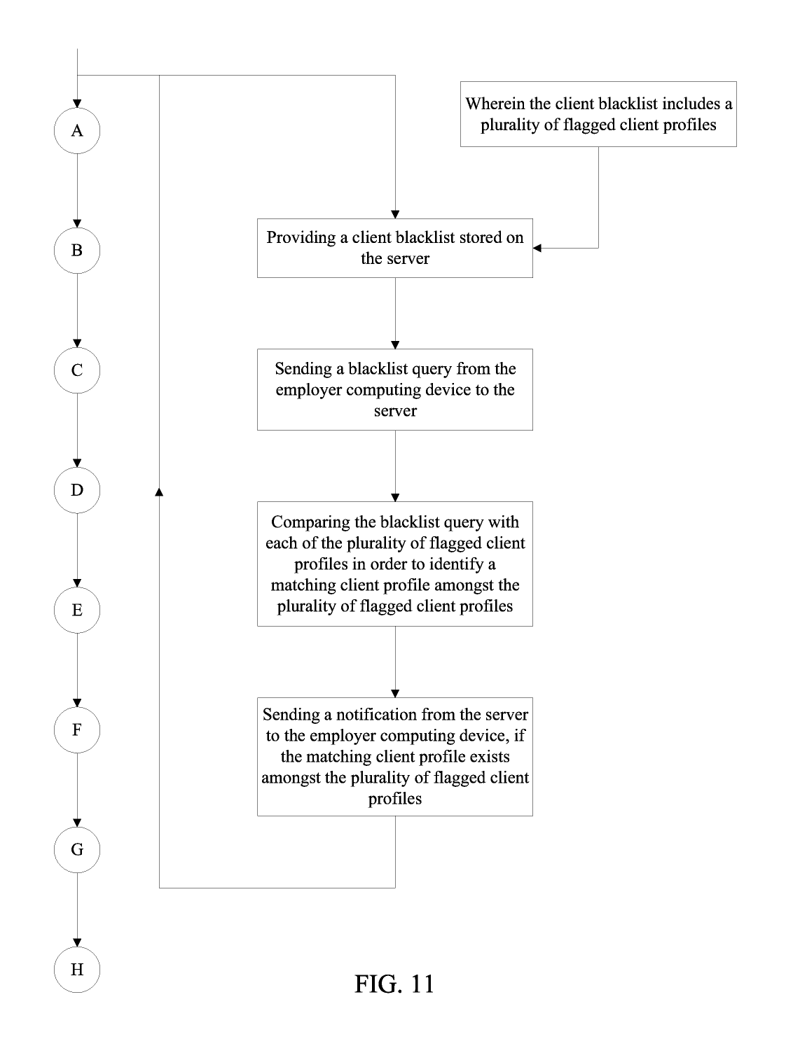

To search for a client on the client blacklist, a blacklist query is sent from the employer computing device to the server. The blacklist query includes information that is used to identify the client. This information may include the name of the client, the client's location, or the client's driver's license information. In reference to FIG. 11, the blacklist query is compared with each of the plurality of flagged client profiles in order to identify a matching client profile amongst the plurality of flagged client profiles. If the matching client profile exists amongst the plurality of flagged client profiles, a notification is sent from the server to the employer computing device. The notification serves to alert the employer if a client cannot be trusted and may include information regarding why there is a flagged profile for that specific client.

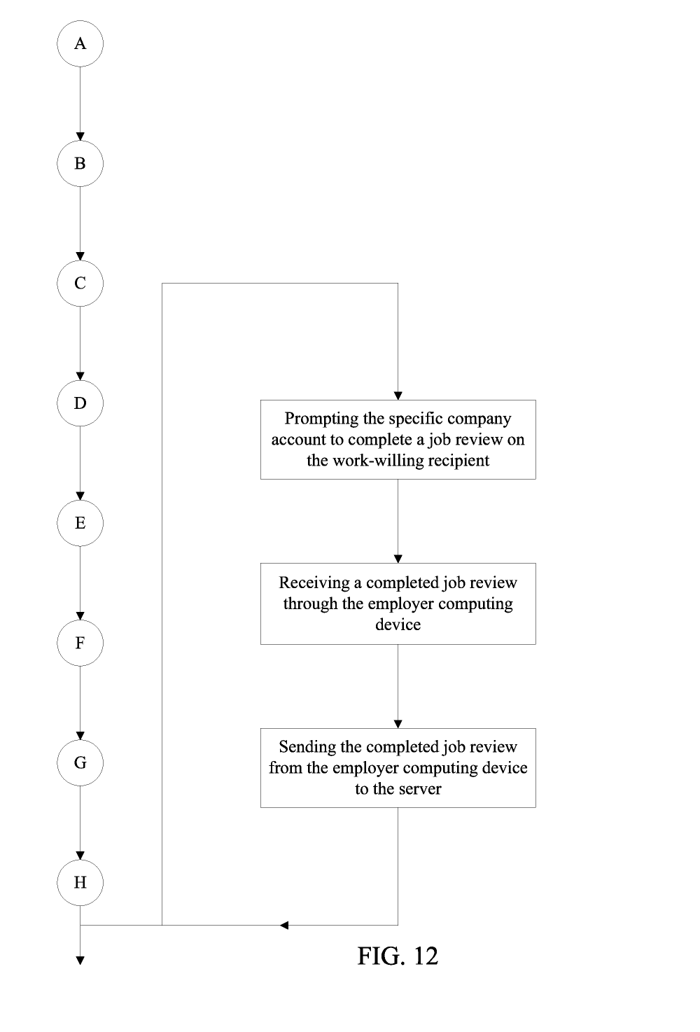

After a job request has been completed and the job completion receipt is sent to the employer computing device, the employer of the specific company account has an opportunity to rate the service provided by the work-willing recipient. To start this process, the specific company account is prompted to complete a job review on the work-willing recipient through the employer computing device. This process is shown in FIG. 12. The employer of the specific company account is able to provide information regarding the overall experience of working with the work-willing recipient. After the employer provides all of the information requested for the job review, a completed job review is received through the employer computing device and is sent from the employer computing device to the server. Job reviews for each of the plurality of agent accounts, each of the plurality of company accounts, and each of the plurality of bounty hunter accounts may be used to prevent some accounts from being considered desired recipients.

Although the invention has been explained in relation to its preferred embodiment, it is to be understood that many other possible modifications and variations can be made without departing from the spirit and scope of the invention as hereinafter claimed.

What is claimed is:

1. A method of providing an electronic bail posting service by executing computer-executable instructions stored on a non-transitory computer-readable medium, the method comprises the steps of:
(A) managing a plurality of company accounts, a plurality of agent accounts, and a plurality of bounty hunter accounts with an at least one server;
(B) displaying a plurality of feature options to a specific company account through an employer computing device, wherein the plurality of company accounts includes the specific company account;
(C) prompting the specific company account to select a desired feature from the plurality of feature options through the employer computing device;
(D) designating a job request with the server, wherein the job request is associated with the desired feature;
(E) designating a plurality of desired recipients with the server, wherein the plurality of desired recipients is either a selection of accounts from the plurality of company accounts, a selection of accounts from the plurality of agent accounts, or a selection of accounts from the plurality of bounty hunter accounts;
(F) sending the job request from the server to a corresponding computing device for each of the plurality of desired recipients;
(G) generating a job acceptance confirmation for a work-willing recipient with either the server or the corresponding computing device of the work-willing recipient, wherein the plurality of desired recipients includes the work-willing recipient; and
(H) sending a job completion receipt from the corresponding assignment device of the work-willing recipient, through the server, and to the employer computing device.

2. The method of providing an electronic bail posting service by executing computer-executable instructions stored on a non-transitory computer-readable medium, the method as claimed in claim 1 comprises the steps of:
wherein the desired feature is a request agent feature and is associated with a client location;
providing an agent location and an agent certification for each of the plurality of agent accounts;
providing insurance information for the specific company account;
comparing the client location to the agent location for each of the plurality of agent accounts in order to identify proximal accounts to the client location, wherein the plurality of agent accounts includes the proximal accounts;
comparing the insurance information to the agent certification for each of the proximal accounts in order to identify certified accounts within the proximal accounts; and
designating the certified accounts as the plurality of desired recipients.

3. The method of providing an electronic bail posting service by executing computer-executable instructions stored on a non-transitory computer-readable medium, the method as claimed in claim 2 comprises the steps of:
providing a job radius, wherein the job radius is centered at the client location;
comparing the job radius to the agent location for each of the plurality of agent accounts in order to identify the proximal accounts to the client location; and

[symbol]

4. The method of providing an electronic bail posting service by executing computer-executable instructions stored on a non-transitory computer-readable medium, the method as claimed in claim 1 comprises the steps of:
wherein the desired feature is a request agent feature and is associated with a client location and with a plurality of incomplete job forms stored on the server;
sending a client location with the job request from the server to the corresponding computing device for each of the plurality of desired recipients;
sending the job acceptance confirmation from the corresponding computing device of the work-willing recipient, through the server, and to the employer computing device;
sending an agent location from the corresponding computing device of the work-willing recipient to the server;
sending the plurality of incomplete job forms from the server to the corresponding computing device of the work-willing recipient;
prompting the work-willing recipient to complete the plurality of incomplete job forms through the corresponding computing device of the work-willing recipient;
sending a plurality of completed job documents with the corresponding computing device of the work-willing recipient to the server; and
managing a monetary transaction from the specific company account to the work-willing recipient with the server.

5. The method of providing an electronic bail posting service by executing computer-executable instructions stored on a non-transitory computer-readable medium, the method as claimed in claim 1 comprises the steps of:
wherein the desired feature is a refer bail feature and is associated with a client location;
providing a company location for each of the plurality of company accounts;
comparing the client location to the company location for each of the plurality of company accounts in order to identify proximal accounts to the client location, wherein the plurality of company accounts includes the proximal accounts; and
designating the proximal accounts as the plurality of desired recipients.

6. The method of providing an electronic bail posting service by executing computer-executable instructions stored on a non-transitory computer-readable medium, the method as claimed in claim 1 comprises the steps of:
wherein the desired feature is a refer bail feature and is associated with client acquisition information stored on the server;
sending a referral fee with the job request from the server to the corresponding computing device for each of the plurality of desired recipients;
sending the job acceptance confirmation from the corresponding computing device of the work-willing recipient, through the server, and to the employer computing device;
managing a monetary transaction from the work-willing recipient to the specific company account with the server, wherein the monetary transaction is quantitatively equal to the referral fee; and
sending the client acquisition information from the server to the corresponding computing device of the work-willing recipient.

7. The method of providing an electronic bail posting service by executing computer-executable instructions stored on a non-transitory computer-readable medium, the method as claimed in claim 1 comprises the steps of:
wherein the desired feature is a fugitive recovery feature and is associated with a client location;
providing a bounty hunter location for each of the plurality of bounty hunter accounts;
comparing the client location to the bounty hunter location for each of the plurality of bounty hunter accounts in order to identify proximal accounts to the client location, wherein the plurality of bounty hunter accounts includes the proximal accounts; and
designating the proximal accounts as the plurality of desired recipients.

8. The method of providing an electronic bail posting service by executing computer-executable instructions stored on a non-transitory computer-readable medium, the method as claimed in claim 1 comprises the steps of:
wherein the desired feature is a fugitive recovery feature and is associated with fugitive acquisition information stored on the server;
sending the fugitive acquisition information with the job request from the server to the corresponding computing device for each of the plurality of desired recipients;
selecting the work-willing recipient from the plurality of desired recipients with the server; and
managing a monetary transaction from the specific company account to the work-willing recipient with the server, wherein the monetary transaction is quantitatively equal to a job price.

9. The method of providing an electronic bail posting service by executing computer-executable instructions stored on a non-transitory computer-readable medium, the method as claimed in claim 8 comprises the steps of:
prompting each of the plurality of desired recipients to place a monetary bid for the job request;
receiving the monetary bid from each of a plurality of potential work-willing recipients, wherein the plurality of desired recipients includes the plurality of potential work-willing recipients;
comparing the monetary bid for each of the plurality of potential work-willing recipients with each other in order to identify a lowest bidder amongst the plurality of potential work-willing recipients;
designating the lowest bidder as the work-willing recipient with the server; and
designating the monetary bid of the lowest bidder as the job price.

10. The method of providing an electronic bail posting service by executing computer-executable instructions stored on a non-transitory computer-readable medium, the method as claimed in claim 1 comprises the steps of:
providing a client blacklist stored on the server, wherein the client blacklist includes a plurality of flagged client profiles;
receiving a flagged client profile through the employer computing device;
sending the flagged client profile from the employer computing device to the server; and
storing the flagged client profile on the client blacklist.

11. The method of providing an electronic bail posting service by executing computer-executable instructions stored on a non-transitory computer-readable medium, the method as claimed in claim 1 comprises the steps of:
providing a client blacklist stored on the server, wherein the client blacklist includes a plurality of flagged client profiles;
sending a blacklist query from the employer computing device to the server;
comparing the blacklist query with each of the plurality of flagged client profiles in order to identify a matching client profile amongst the plurality of flagged client profiles; and
sending a notification from the server to the employer computing device, if the matching client profile exists amongst the plurality of flagged client profiles.

12. The method of providing an electronic bail posting service by executing computer-executable instructions stored on a non-transitory computer-readable medium, the method as claimed in claim 1 comprises the steps of:
prompting the specific company account to complete a job review on the work-willing recipient through the employer computing device;
receiving a completed job review through the employer computing device; and
sending the completed job review from the employer computing device to the server.
